(19) United States
(12) Patent Application Publication
(10) Pub. No.: US 2012/0290387 A1
(43) Pub. Date: Nov. 15, 2012

(54) System and Method of Advertising for Objects Displayed on a Webpage

(75) Inventor: Timothy Davis, Murrumbeena (AU)

(73) Assignee: Fluc Pty Ltd., Melbourne (AU)

(21) Appl. No.: 13/508,295

(22) PCT Filed: Nov. 5, 2010
(86) PCT No.: PCT/AU10/01480

§ 371 Date: Jul. 30, 2012

(30) Foreign Application Priority Data
Nov. 7, 2009 (AU) 20099905444

(51) Int. Cl. G06Q 30/02

(52) U.S. Cl. 705/14.49

(57) ABSTRACT

A method of advertising for objects displayed on a webpage of a website hosted by a web server accessible over a network, the method comprising electronically associating one or more objects displayed in an element on the webpage with respective keywords identifying the one or more objects, retrieving advertising data for the one or more objects based on the respective keywords from at least one data store in data communication with the web server, and outputting the advertising data with the one or more objects for display with the element on the webpage.

### FIELD OF THE INVENTION

The present invention relates to a system and method of advertising for objects displayed on a webpage particularly, but not exclusively, outputting advertising data with the objects for display with an element on the webpage.

### BACKGROUND OF THE INVENTION

Advertising on the Internet today is generally seen as a critical revenue stream for many online businesses. Most online businesses or system application owners, such as mobile phone or gaming companies etc., attempt to utilize as many different sources of advertising technologies as possible on their websites in order to maximize the income they generate for the content they provide to internet users.

It has been detailed that a critical aspect of increasing revenue for online business or system application owners is to utilize the power of crowd sourcing. That is, allowing website users, members or visitors to interact with machine identified content on a web page and identify the elements on or within said content. Providing users with the ability to interact with this content allows website or system application owner's visitors, members or users of the website or system application to identify elements on the webpage for the products of advertising or product identification.

### SUMMARY OF THE INVENTION

According to one aspect of the present invention, there is provided a method of advertising for objects displayed on a webpage of a website hosted by a web server accessible over a network, the method comprising:

electronically associating one or more objects displayed in an element on the webpage with respective keywords identifying the one or more objects;

retrieving advertising data for the one or more objects based on the respective keywords from at least one data store in data communication with the web server; and

outputting the advertising data with the one or more objects for display with the element on the webpage.

In an embodiment, the method further comprises generating data corresponding to a user demarcation of the one or more objects displayed in the element. Furthermore, the method further comprises generating further data corresponding to a subsequent user demarcation of the one or more objects displayed in the element. In an arrangement, the method further comprises comprising comparing said data and said further data, and confirming position of the one or more objects displayed in the element if said data corresponds substantially (e.g. 70% overlap) to said further data. In this case, the method further comprises storing said data in association with the advertising data for the one or more objects in the at least one data store.

In an embodiment, the method further comprises receiving the respective keywords identifying the one or more objects from users accessing the webpage over the network. In the embodiment, the method further comprises generating keywords for selection by the users to further identify the one or more objects upon receipt of the respective keywords.

According to one aspect of the present invention, there is provided a system for advertising for objects, the system comprising:

a web server accessible over a network for outputting a webpage of a website hosted by the web server; and

an advertising module arranged to:

receive keywords identifying one or more objects displayed in an element on the webpage;

associate the one or more objects with the respective keywords;

retrieve advertising data for the one or more objects based on the respective keywords from at least one data store in data communication with the web server; and

output the advertising data with the one or more objects for display with the element on the webpage.

In an embodiment, the element comprises an image displayed on the webpage.

In an embodiment, the advertising module is further arranged to generate data corresponding to a user demarcation of the one or more objects displayed in the element.

In an embodiment, the advertising module is further arranged to generate further data corresponding to a subsequent user demarcation of the one or more objects displayed in the element.

In an embodiment, the advertising module is further arranged to compare said data and said further data, and confirm position of the one or more objects displayed in the element if said data corresponds substantially to said further data.

In an embodiment, the advertising module is further arranged to confirm position of the one or more objects if said data corresponds by an overlap factor of 70%.

In an embodiment, the advertising module is further arranged to store said data in association with the advertising data for the one or more objects in the at least one data store. It will be appreciated by those persons skilled in the art that the at least one data store may be a further data store in data communication with the web server.

In an embodiment, the advertising module is further arranged to output the advertising data for the one or more objects for display with the element on the webpage to further users.

In an embodiment, the advertising module is further arranged to output the advertising data in response to a cursor position of the further users indicating the one or more objects displayed on the webpage.

In an embodiment, the at least one data store resides on the web server. In one arrangement, the advertising module resides on the web server.

In an embodiment, part of the advertising module resides on the web server.

In an embodiment, the advertising module is further arranged to receive the respective keywords identifying the one or more objects from users accessing the webpage over the network.

In an embodiment, the advertising module is further arranged to generate keywords for selection by the users to further identify the one or more objects upon receipt of the respective keywords.

In an embodiment, the advertising module is further arranged to designate elements on the webpage in which keywords identifying one or more objects displayed in those elements can be received.

In an embodiment, advertising module is further arranged to designate elements on the webpage based on pixel size of the elements. In an example, the elements are images and the advertising module designates only images with greater than a predetermined pixel size which keywords can be received.

In an embodiment, the advertising module is further arranged to generate a demarcation of the one or more objects displayed in the element for user confirmation.

In an embodiment, the advertising module is further arranged to generate the demarcation in response to a user cursor position indicating the one or more objects displayed on the webpage.

In an embodiment, the advertising module allows website or system application visitors, members and users to mark specific data on a webpage or application object or element in order to enter keyword information relevant to the marked area for the purposes of delivery product or advertising information relevant to the said marker can only be achieved with sufficient data structure interaction.

In an embodiment, the advertising module allows interacting with data structures in order to transform data passed between the client identification interface and the data structure in order to most relevantly allow any user of the system to identify and mark on any particular webpage element the correct keyword relevant to the object which is disclosed. This disclosure ensures that the user will be able to more accurately identify the said object within the web page or application element by ensuring visually that they are able to match the said object to a list formed from a said data structure.

It is envisaged that one aspect of identifying objects, elements or product data within or on webpage elements (e.g. images) is through the automatic data structure matching of user marked data. Thus, the embodiment allows any website to integrate the advertising module, in the form of binary code, onto their webpage and allow their website users, visitors or members to mark and identify said objects or webpage elements (e.g. images, such as, but in no way limited to, photos, text and video within or on the webpage) for the purposes of saving this information into a data structure (e.g. a data store as described above) and then redisplaying this product and/or advertising data (e.g. information) each time the webpage or application is loaded by subsequent users.

The ability for website or application owners and publishers to integrate an external piece of binary code, in the form of the advertising module, enables them to both provide metadata about objects and elements within their own web pages or application elements in addition to allowing their users, members and visitors identify, mark and provide keyword metadata about objects and elements within a webpage for advertising generation using crowd sourcing or multiple visitor, user or member verification methodologies to confirm that the object identified is the correct object. The additional step of allowing users, visitors and members to mark this keyword information through shape vectorisation allows the advertising module to match marked shape vectors through the use of shape vectorisation area matching which then allows the data structure to co-ordinate previously identified objects and redisplay them to subsequent website users, visitors or members. The data structure is also able to search the relevant keyword information entered by the user marking the product to previously collated and stored object data for the purposes visually matching the identified object to that any object found in the data structure.

In an embodiment, shape vectorisation technology is utilised to accurately allow users to interact within elements of a webpage in order to identify the content (e.g. objects) in the webpage.

In another embodiment, the advertising module allows website or system application visitors, members and users to mark specific data on a webpage or application object or element in order to enter keyword information relevant to the marked area for the purposes of delivery product or advertising information relevant to the marker can only be achieved with sufficient data structure interaction.

In an embodiment, the methodology of interacting with data structures transforms data passed between the client identification interface (e.g. client Internet browser) and the data structure in order to most relevantly allow any user of the system to identify and mark on any particular webpage element the correct keyword relevant to the object which is displayed. This ensures that the user will be able to more accurately identify the object within the web page or application element by ensuring visually that they are able to match the object to a list formed from said data structure.

In an embodiment, the system and method allows a specific website to match product and advertising content (e.g. advertising data) to marked objects.

In an embodiment, the system comprises an identification module which allows the system to identify and store in a structured database the dimensions of said webpage or application elements in order to determine the relevant dimensions of the elements or objects contained within a webpage or application.

In an embodiment, the system comprises a vector area module which allows the system to store and determine the area contained within a website user, visitor or member drawn vector shape(s) on elements or objects within a webpage or application for the purposes of matching overlap between said marked vector shape areas and determining intersection between said marked vector shape areas against a predefined percentage and/or overlap ratio stored in the data structure.

In an embodiment, the system comprises a ranking module which allows the system to increase or decrease the accuracy and relevancy of data entered by subsequent website users, visitors or members who further provide vector shapes and keyword data in comparison to that of previous website users, visitors or members in relation to stored product and advertising data in the data structure.

In an embodiment, the system comprises a customisable binary code creation module which allows a user to customise the respective number of elements which are activated on and in any said media content for use by the system.

In an embodiment, the system comprises a product and/or keyword search module which attempts to display a list of products and/or keywords relevant to that entered by the user with a relevant visually represented preview of the product and/or keywords for the purposes of providing a visual representation of the object marked by the user, visitor or member.

In an embodiment, the system comprises a keyword to advertising search module which allows the system to identify confirmed keywords and determine the highest commission based and/or most relevant advertising data to deliver to display with the marked vector shape (and/or marked vector overlap) for each uniquely identified object.

In an embodiment, the system comprises a tracking and advertising commission module which allows the system to track approved advertising from the advertising matched to the uniquely identified object for the purpose of income generation and paying system users.

In an embodiment, the system comprises a computer configured to implement the above described modules. In an arrangement, the computer is the web server.

In accordance with another aspect of the present invention there is provided a computer program code which when executed implements above the described method.

In accordance with another aspect of the present invention there is provided a tangible computer readable medium comprising the above program code.

In accordance with another aspect the present invention provides transmitting or receiving the above program code.

### BRIEF DESCRIPTION OF THE DRAWINGS

In order that the invention can be more clearly ascertained, embodiments will now be described, by way of example, with reference to the accompanying drawings, in which:

FIG. 1 is a schematic view of a system according to an embodiment of the present invention;

FIG. 2 is a flow chart of a method implemented by the system of FIG. 1 according to an embodiment of the present invention;

FIG. 3A is part of a further flow chart of a method implemented by the system of FIG. 1 according to an embodiment of the present invention showing the start of the flow chart to (A) (B);

FIG. 3B is part of the further flow chart showing from (A) (B) to (C) (D);

FIG. 3C is part of the further flow chart showing from (C) (D) to the completion of the flow chart;

FIG. 4 is a screen shot according to an embodiment of the present invention;

FIG. 5 is a screen shot according to an embodiment of the present invention;

FIG. 6 is a screen shot according to an embodiment of the present invention;

FIG. 7 is a screen shot according to an embodiment of the present invention; and

FIG. 8 is a screen shot according to an embodiment of the present invention.

### DETAILED DESCRIPTION

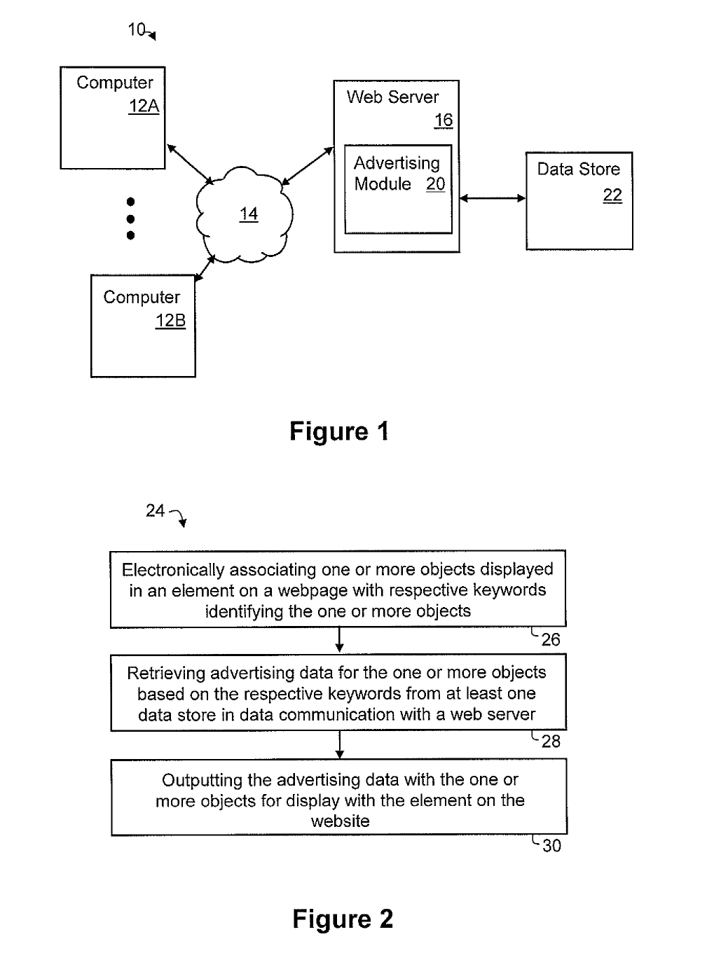

According to an embodiment, there is provided a system 10 for advertising for objects displayed on a webpage of a website hosted by a web server 16 accessible over a network 14, as shown in FIG. 1. The system 10 comprises an advertising module 20 arranged to receive keywords identifying one or more objects displayed in an element on the webpage, associate the one or more objects with the respective keywords, retrieve advertising data for the one or more objects based on the respective keywords from at least one data store 22 in data communication with the web server 16, and outputting the advertising data with the one or more objects for display with the element on the webpage. As shown in FIG. 1, the advertising module 20 resides on the web server 16 and is implemented by the web server 16 to enable user computers 12A 12B accessing web pages over a network 14, such as the Internet, to input keywords to be associated with the one or more objects displayed to the users of the computers 12A 12B in elements displayed on web pages.

In addition, the advertising module 20 generates data corresponding to a user demarcation of the one or more objects displayed in the element. For example, a user of the computer 12A can mark an area on a displayed element using a pointing device, such as a mouse, to mark an object displayed in the element and data corresponding to this user demarcation is generated. Furthermore, a subsequent user of the computer 12B can also mark the area on a displayed element corresponding to the same object and the advertising module 20 generates further data corresponding to the subsequent user demarcation of the object. In the example, the advertising module 20 compares the two sets of generated data to confirm position of the object displayed in the element when the generated data substantially corresponds. Furthermore, the advertising module 20 then stores the confirmed position data in association with the advertising data for the object in the data store 22. Thus, further users browsing the same webpage can view the displayed element (e.g. an image) with the confirmed object marked accordingly and identified by a keyword (e.g. a handbag), along with advertising data based on the keyword (e.g. images of handbags for sale) when locating their mouse over the object.

In another example, the advertising module 20 is arranged to generate the demarcation of the object displayed in the element for user confirmation rather than a user demarcation. For example, the user of computer 12A selects an object displayed in an image on a web page using a mouse and the advertising module 20 generates a suggested demarcation of the object to the user. The user can then confirm the demarcation or edit the suggested demarcation to mark the object accordingly.

In addition, to more accurately associate the object displayed in the element on the webpage with the correct keyword, the advertising module 20 generates keywords for selection by the users to further identify the object upon receipt of a keyword. For example, the advertising module 20 receives the keyword “handbag” and interrogates the data store 22 to retrieve further keywords for selections such as various brands of handbags for a user to select. The advertising module 20 receives the user selection and subsequently stores this selection in association with the advertising data for the object in the data store 22.

The advertising module 20 is also arranged to designate elements on the webpage in which keywords identifying objects displayed in those elements can be received. That is, the advertising module 20 can be configured to activate certain elements. For example, a website publisher may wish that only images with a pixel size greater than 500×500 should be activated to have objects displayed in those images identified for displaying advertising data to users.

Referring now to FIG. 2, a method 24 of advertising for objects displayed on a webpage is summarised. The method 24 comprises electronically associating 26 one or more objects displayed in an element on the webpage with respective keywords identifying the one or more objects, retrieving 28 advertising data for the one or more objects based on the respective keywords from at least one data store in data communication with a web server hosting the webpage, and outputting 30 the advertising data with the one or more objects for display with the element on the webpage.

The method 24 allows for a website or application user, visitor or member (or other) to mark said objects within a webpage or application which have been identified by the system for the purposes of matching such identified objects with data collated inside the data structure 22 (e.g. the data store 22).

The method 24 is also able to correlate multiple marks together and compare these differing marked co-ordinates inside the data structure 22 in order to determine and identify the relevant object within the shape vectorisation overlap. The purpose of determining the area of the marked shape is to match the marked area to other subsequent marked shape areas on the same object or element for the purposes of determining vector shape overlap and allowing the system to aggregate and match such data accordingly. It is envisaged that the increased correlation between shape overlap and keyword matching would assist the system 10 in determining the most appropriate product or advertising content (e.g. advertising data) to be matched to the relevant marked data webpage or application element or object. It is noted that a webpage or application element can include any textual information, non-textual information such as image, video and audio and any other interaction embodiment available.

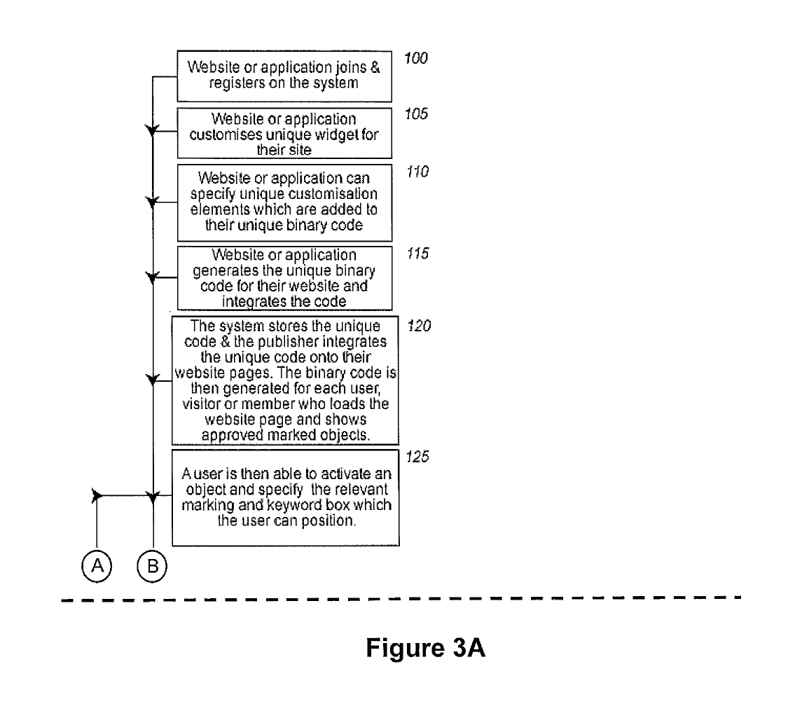

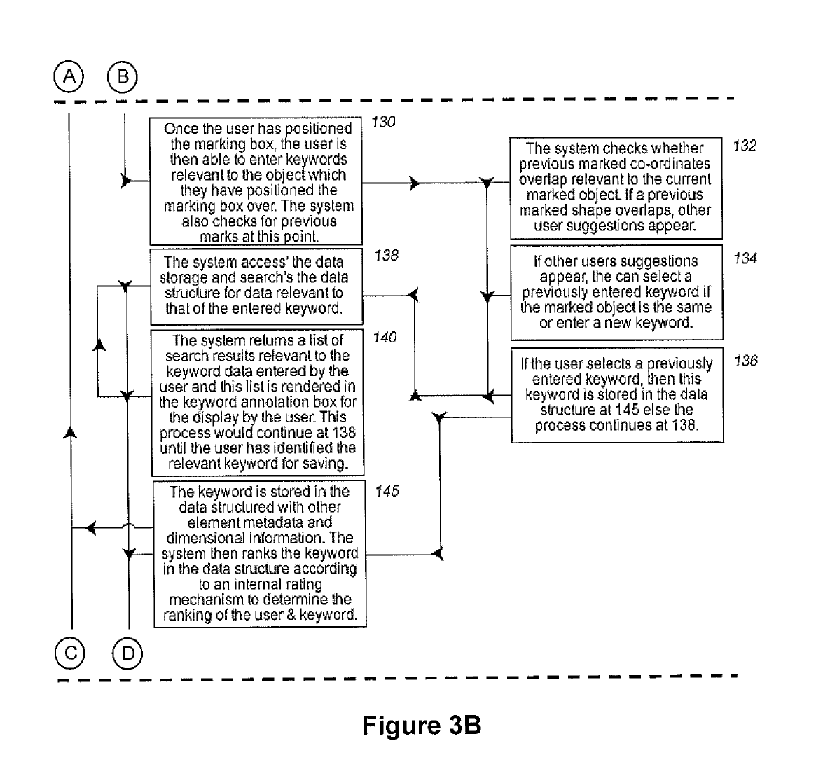

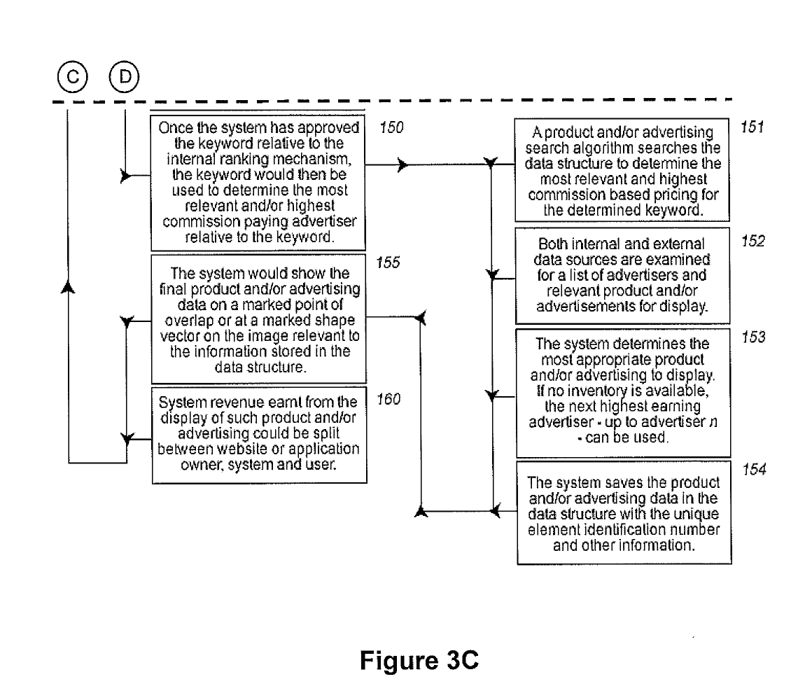

The example shown over FIGS. 3A, 3B and 3C shows how a non-limiting iteration of the method 24 implemented by the system 10 would operate.

Firstly, at 100 a website or application owner would register and join the system 10. That is, the website or application owner would operate the advertising module 20 on their web server 16. The registration information recorded by the advertising module 20 would include information such as, but in by no way limiting, website URL, application name or ID, contact name and details, mobile phone number, a unique username and email address. These details would be stored in the data structure 22 (or data structure 22) in data communication with the web server 16. On joining, the website or application owner would also be assigned a unique alphanumeric publisher identification code which would be unique to the account of the publisher.

Once a website or application has joined and registered with the system, the website or application is able to customise, at 105, the advertising module 20 in the form of a unique widget for their site. It is envisaged firstly that the customisation of the binary system code of the advertising module 20 would provide the website or application account owner with the ability to specify, but in no way limiting, their website name, their website URL (uniform resource locator), application name or ID, their website or application tag name or tag line and their website or application name logo or product identification symbol by uploading a file to the data structure 22 or by providing a URL link to their logo or product identification symbol. It is envisaged that a single account could manage multiple websites from the same account in this regard.

At 110, the website or application owner would be able to specifically customise their binary system code to their website and particularize how they would like users, visitors or members to identify objects within or on elements within their webpage and how resulting marked locations appear with relevant product and/or advertising information. It is preferable that a website or application owner would be able to specifically exclude or include elements which are then automatically excluded or included respectively in relation to the binary system code. In a non-limiting capacity and for the purposes of identification and activation of the relevant binary system code over said webpage or application elements, it is envisaged that the system would provide a website or application owner with the ability to customise which elements are recognised by the system to allow users, visitors or members to mark and interact with. It is envisaged that a website or application owner would be able to specify individual URL cascading style sheet addresses or system application design code which the system would automatically exclude any elements specified within the style sheets or code specified. It is also envisaged that a website or application would be able to exclude particular media or file types such as, but not limited to, image file types (*.gif, *.jpg, *.png etc) or video image types (*.mpg, *.mpeg, *.fly etc) or audio types (*.mp3, *.mp4, *.way etc) and the binary system code would automatically exclude activating these elements for interaction with website or application users, visitors or members. It is further envisaged that website or application owners would be able to exclude individual media or file type dimensions such as, but not limited to, activating no interacting elements below a particular width and height and depth or, alternatively, activating all elements over a particular width and height. In addition, the website or application would be able to specify URLs where web page or website content or application data is loaded from for exclusion so that any elements which are loaded from these specific URLs are not activated by the advertising module 20 for interaction and marking with said users, visitors or members.

It is also envisaged that a website or owner would be able to specify whether the advertising module 20 confirmed and approved identification marks showing product and/or advertising information can appear over elements when the webpage(s) or application first load or only upon further interaction by said users, visitors or members of the webpage. In addition, the website or application owner would also be able to specify the maximum number of confirmed and approved identification marks showing product and/or advertising information which appear over any uniquely identified webpage or application element, such that no single element has too many confirmed product and/or advertising marks placed over or inside it.

At 115, once the website or application owner has customised their unique system binary code, they would be able to request that the system generates their unique code and associates a unique alphanumeric website identification code with the generation of the unique system code. It is envisaged that this binary system code would be, but in no way is limited to, a script and/or binary code file containing the unique customisations by the website or application owner and it is envisaged that this information may be stored in the data structure 22 accordingly.

At 120, once the binary code is generated then the website or application owner can integrate this code into their website pages or application design structure where they want the binary system code to activate relevant elements according to their respective customisations. In this regard, elements which meet the unique customisation specifications relevant to the publisher's creation of the binary system code are assigned unique system element identification codes which allow each element to be identified and stored within the data structure 22. Thus, each element on a webpage or application, and any subsequent elements which are introduced onto or into any specific web page or application, are provided a relevant alphanumeric element identification number which is stored in the data structure 22 with the relevant website or application and publisher identification codes.

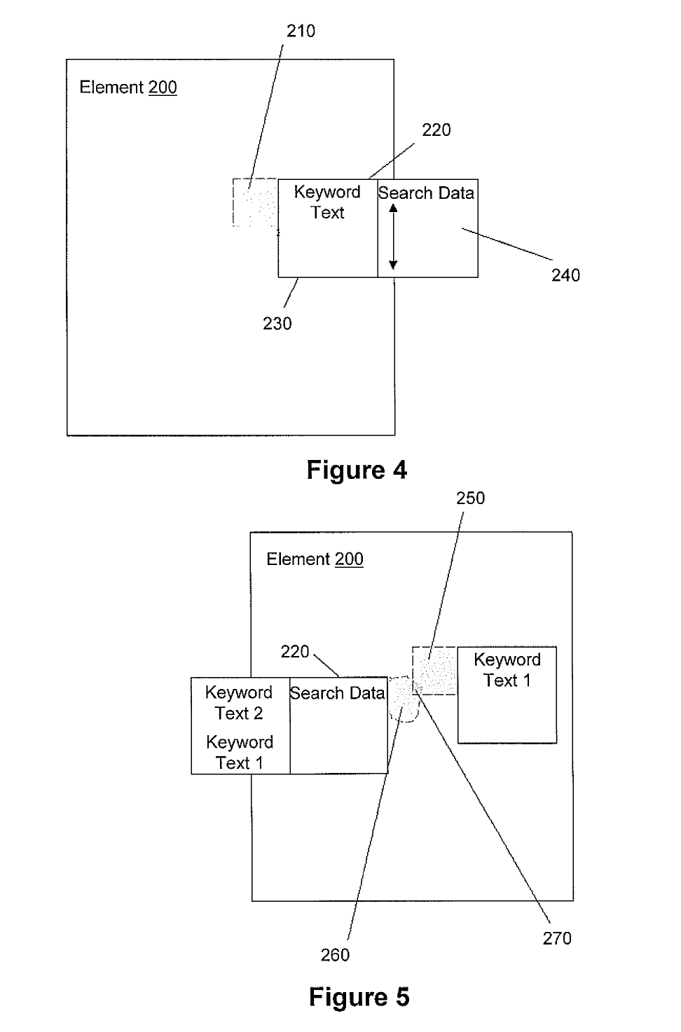

At 125, all elements have been recognised by the binary system code, which has been integrated onto the relevant website or application pages (e.g. residing on the web server 16), and the advertising module 20 has enabled and/or activated the generated code to allow these elements to be recognised and activated by users, visitors or members which activate the system integrated code for each uniquely identified element by utilising the relevant user input whether this be, in no way limiting, a keyboard, mouse or touch input device or some other user input mechanism when moving over or selecting the respective element. It is envisaged that the system will be able to identify in respect of the elements the relevant dimensions and specific element metadata for storage in the data structure 22 including, each considered separately and each non-limiting, height, width, depth, length, time, frames per second and other element specific metric metadata available depending on the recognised element. When a user activates the respective element a vector positioning shape 210 appears over the element 200 with a relevant keyword identification box 220, as pictured in FIG. 4.

FIG. 4 shows a displayed element 200 and a Marked Vector Shape 210 that a user will be able to position, resize, expand or contract anywhere inside the boundary limitations of the element 200. As the user positions, resizes, expands or contracts the relevant marked vector shape 210 the relevant horizontal, vertical and depth co-ordinates of each point on the marked vector shape 210 can be ascertained, or generated by the advertising module 20, relevant to the dimensional components of the element.

At 130, once the user, visitor or member has positioned the marked vector shape 210 over the relevant element, the user is then able to enter keywords relevant to that enclosed by the confinements of marked vector shape in reference to the specific metadata of the element. The user is able to click on an input data box 230 termed ‘Keyword Text’ shown in FIG. 4 and enter a descriptive keyword through an aforementioned input device relevant to the object so marked by them. Once a user has entered a descriptive keyword, the advertising module 20 recognises that the user has finished positioning the marked vector shape 210 and sends the co-ordinates of the shape 210 outlined in FIG. 4 to the data structure 22 to determine whether, for this unique element identification number on this unique website, there have been previously marked vector shapes by previous users. In addition, the input data box 230 includes a user suggestions field, which displays other user's identification and/or commentary if there is requisite overlap, for other users to add comments to be displayed and a search data field 240 to be populated with search data relevant to the inputted keyword data.

At 132, and as outlined in FIG. 5, the advertising module 20 determines whether there is any said vector shape overlap 270 between previously uniquely identified marked vector shapes, shown as Marked Vector Shape 250 for illustrative purposes in FIG. 5, and the current uniquely identified marked vector shape 260. The advertising module 20 determines this overlap 270 by analysing the co-ordinate boundary points of the uniquely identified marked vector shape in the data structure 22 and determining intersection points with said previous uniquely identified marked vector shape points in the data structure 22 relative to the element dimensions. If vector overlap is found (e.g. the advertising module 20 determines that there is greater than 70% overlap) between previously marked vector shape 250 points and the current marked vector shape 260 points, then the keyword data saved in the data structure 22d and previously saved uniquely identified marked vector shapes are retrieved from the data structure 22 and shown to the current user to determine whether the current user is of the view that this keyword data correctly identifies the object in the element boundary.

At 134, it is preferable that once previous keyword data is retrieved from the data structure 22 and shown to the current user in the keyword annotation box 220, the user can either select a previously entered keyword or determine that previously entered keywords do not specifically identify the relevant object identified by the marked vector shape in the current element.

At 136, if the user, visitor or member of the website determines the previously matched vector shape overlap 270 keyword(s) does correctly identify the object surrounding the current marked vector shape 260 then the user can select this previously identified keyword and the process would continue to 145. Alternatively, if the user is of the view that the previously matched vector shape overlap keyword(s) do not correctly identify the object surrounding the current marked vector shape 260 then the process moves to 138.

At 138, the keyword entered into the Keyword Text input box 230 is sent to the data structure 22 which searches for and retrieves aggregated data from internal or external data structures or aggregated data from existing data sources relevant to the keyword entered by the user and displays this information in Search Data 240 list in FIG. 4 in the Keyword

Annotation Data Box 220. In a non-limiting example, the data structure 22 may search for similar product or service data according to keyword entered by the user which best describes the object marked within the marked vector shape such as by universal product identification code, category or relevancy or other factors which are relevant to the keyword search index.

At 140, the data structure 22 would then identify and return a number of products or services—nₗᵢₛₜ—which the search data structure 22 determines is relevant to the entered keyword. This list of products or services would preferably be sent back to the client side keyword box 240 in binary form—such as but not limited compressed JavaScript Object Notation (JSON)—and include such data as, but in no way limiting, product name, service name, manufacturer name, image URL, top level product category, second level product category and other information which would allow the user to preview products or services relevant to their entered keyword. It is envisaged that such a list would allow the user to position their input device over the returned search results in order to trigger the display of a visually rendered representation of the particular keyword or service in the list to compare this to the object enclosed by the marked vector shape. The user is then able to repeat this process by returning to 130 to enter a new keyword and have a new search list rendered at 140 until the user has selected a relevant keyword data which they are of the opinion represents the object surrounding by the marked vector shape 210 within the element 200, and the process moves to 145.

At 145, the data structure 22 has saved the relevant keyword data with the unique website or application identification code, unique system element identification code, unique mark shape vector identification code in addition to numerous other data retrieved from the search result list such as, but in no way limited to, product name, manufacturer name, image URL, top level product or service category, second level product or service category and other data information as necessary in broad scope and view. It is envisaged that an internal rating mechanism would be used for each element saved to the data structure 22 by comparing all data available for each uniquely identified system identified webpage element. This would include a comparison of, but in no way limiting, whether the user marking the object within an element on a webpage or application was a system registered user for the purposes of marking or whether the user was merely a non-registered user of the system—such as but not limited to a visitor of the website—who has utilised the system. It is envisaged that this system would allow for points to be awarded for correctly identified objects within elements which are confirmed by subsequent users. If an object identified by a user within an element marked by a vector shape is confirmed by the system in the data structure 22 such that the element is approved by the internal ranking mechanism—then the advertising module 20 identifies that this keyword as confirmed for the unique element identification code and the unique marked vector shape identification code and the process moves to 150. If the an object identified by a user within an element marked by a vector shape is not confirmed by the data structure 22 such that the element is not approved by the internal ranking mechanism—then the advertising module 20 identifies that this keyword is not confirmed for the unique element identification code and the unique marked vector shape identification and the process returns to 125 until the advertising module 20 confirms a unique keyword.

At 150, the advertising module 20 has approved the keyword relative to the internal ranking mechanism and the keyword would then be used to match the most appropriate advertiser, product and or advertisement to the relative keyword for the purposes of redisplay over the marked vector shape co-ordinate points.

At 151, a system keyword product and/or advertising search algorithm would then search at least the data structure 22 to determine a list of the most relevant and/or highest based commission pricing products, advertiser or advertisement for the keyword. It is envisaged that this separate service would only operate once the keyword has been confirmed by the advertising module 20 at 150 and then a relevant advertisement and/or product would be located relevant to the data structure 22 saved information pertaining to the uniquely identified element and mark codes for the respective system website or application.

At 152, it is envisaged that both an internal advertising system facilitating its own advertising and product data would be searchable by this algorithm in addition to the integration of any external data sources and/or services which provide advertising and/or product services which could be within the permissible scope of integration and search for this algorithm.

At 153, it is envisaged that the advertising module 20 would then determine the most appropriate product and/or advertising to display relevant to the data sources within the data structure 22 and to the relevant keyword for the unique element and marked vector shape. The advertising module 20 would determine the most relevant appropriate product and/or advertising by attempting to match products and/or advertisements which are closely related to the keyword or a derivative of the keyword such that a product is related to that which was identified by the user, visitor or member within the boundaries of the marked vector shape. It is envisaged that the advertising module 20 would organise products, advertisers and/or advertising within the system in a structured order as a result of this search such that if one advertiser, or product or advertising inventory is not available then the subsequent next best available search result could be utilized.

At 154, the advertising module 20 saves the top search result based on factors such as, but in no way limited to, commission return, advertising return, price, relevance, number of sales and other related information for determining the most appropriate advertising and/or product. The advertising module 20 would then save the first and/or best result as determined by the search algorithm with the uniquely identified element and uniquely marked vector shape and/or overlap in the data structure 22 for the purposes of retrieval and display on the element.

At 155, the uniquely marked vector shape overlap position or the highest ranked marked vector shape for the element would provide the position co-ordinates for the display of the relevant product discovered in the search algorithm. It is envisaged that such said information would appear by the positioning of an identifiable marker on the element such as, but not limited, a circular image, a frame highlight, a product highlight or similar identification which could be activated by aforementioned input devices when a user selects or presses or activates in any manner the identifiable marker. The activation of the marker would then provide the relevant advertising information box from the search algorithm relating to the best found product, advertiser and/or advertising which was saved with the uniquely identified data in the data structure 22 at 154.

At 160, the advertising module 20 can then track or have the capacity to permit other systems to track and integrate these external systems, the relevant data correlated to the display of such product, advertiser and/or advertising, such as but not limited to, the number of sales, the number of clicks, the number of impressions and other quantifiable tracking information for the purposes of revenue. It is envisaged that this would be tracked to each individual uniquely marked shape vector and each uniquely identified element and website and publisher identification codes. It is then envisaged that the process would repeat from 125 for each said unique element on the website.

As described above, the system 10 and method 24 allow for the specific identification of objects within elements on a webpage or application for the purposes of entering keyword information to describe the area marked by a vector shape and for the purposes of correlating advertising to such information.

A non-limiting example of how the system 10 may operate for a website is as follows. Disney.com joins the system and integrates the advertising module 20 onto their web server 16. Disney.com would provide relevant registration system information, such as website URL, contact name and details, mobile phone number, a unique username and email address, which would be stored in the data structure 22. Disney.com would then be assigned with a unique alphanumeric publisher identification code.

Once Disney.com has integrated the relevant code for the advertising module 20, they would be able to register their particular domain names. In this non-limiting example, Disney.com has registered the Disney.com domain name in order to integrate the system generated binary code onto their respective and individual web pages. Disney.com elects to exclude all media (i.e. elements) except images which it wants to include over the size of 500 px in width and 500 px in height for the purposes of integration of the system code onto their webpage. Disney.com then generates their system binary code in javascript format and integrates this onto their web pages.

The binary system code is now activated on the Disney.com website and the advertising module 20 would then activate only images greater than 500 px in width and 500 px in height and calculate the relevant dimensions of said elements on the page. The binary system code would associate a unique element identification number to each element greater than the 500 px in width and 500 px in height and store this information with the dimensional information in the data structure 22. This would infer that if four images on the Disney.com webpage were greater than 500 px in width and 500 px in height that the advertising module 20 would associate alphanumeric element identification numbers n_{0→∞} each element and as more elements are added from the Disney.com page. This infers that if the page is dynamically changing, the element identification number simply increases for the Disney.com webpage and allows the advertising module 20 to uniquely identify each element within the page according to the unique customisation information. It is envisaged that the advertising module 20 would allow Disney.com to change customisation elements at any time such that they could change the dimensional restriction information (for example 450 px in width and 450 px in height) or include more media content and the advertising module 20 would simply then include new elements and assign them a unique identification code relevant to the changed customisation binary code.

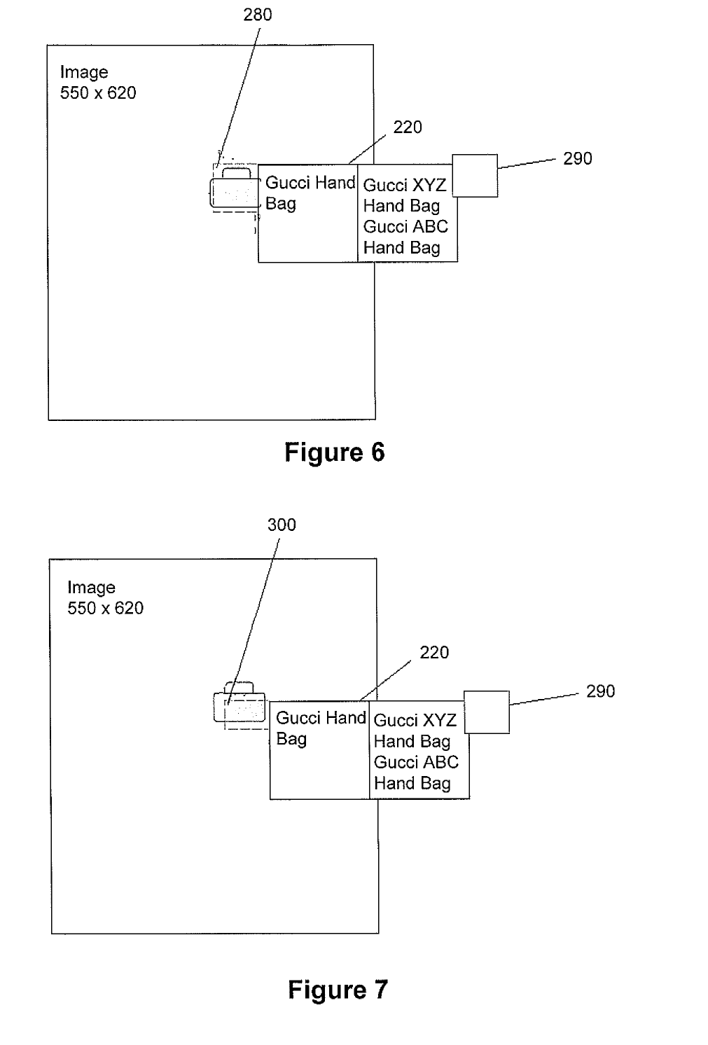

In the example, the advertising module 20 now recognises that there are four elements on the webpage which are image elements and which are activated, recognised and stored with specific identification numbers for the Disney.com unique website inside the data structure 22. It is envisaged that when a user, visitor or member activates any of these four image elements by utilising a relevant user input device such clicking their mouse or touching a screen on the element, the advertising module 20 activates the respective vector positioning shape over the element and within the dimensional confinements of the element with a relevant keyword identification box as pictured in FIG. 6.

It is envisaged that the user is then able to position this vector positioning shape 280 by moving it around the dimensional confinements of the image with their relevant input device, such as by dragging the vector positioning shape with their mouse or moving the shape around with their finger in the instance of touch control. In this non-limiting example, the current activated image features a Gucci ABC Handbag which the user who has activated for the unique image element has knowledge of, as pictured in FIG. 6. The dimensional information listed identifies the unique points of the marked vector shape 280 to determine the relevant co-ordinates of the marked vector shape 280 relevant to the image element on the Disney.com webpage which is then stored in the data structure 22.

The user who has activated the advertising module 20 through said input is then able to enter the corresponding keyword identifying this relevant object in the image, in this case the user would enter ‘Gucci ABC Handbag’ which would then search the data structure 22 using the search algorithm to retrieve information relevant to this search term from internal and externally source data. The results of this search are delivered to Keyword Annotation Data Box 220 from the data structure 22 and then presented in the Keyword Annotation Data Box 220 in the Search Data 240 section. When a user hovers or presses or selects their input device over one of the returned results in the Search Data 240 section, the user is presented with a visual media preview 290 of the relevant term. This visual preview 290 could be any media file available such as, but not limited to, a video, image or audio file or other type of media. In the example shown in FIGS. 6 and 7, it is envisaged that when the user hovers their mouse over the returned keyword ‘Gucci ABC Handbag’ a preview image of this product would appear which the user could then correlate with the marked vector shape highlighting the object within the image element.

In one example, the user identifying the object with the uniquely identified image element has not registered with the system, although it is envisaged that the user would be able to register with the system from the ‘Keyword Annotation Data Box’ 220 and consequently become a registered user of the system by entering such information as their email, username, mobile phone or other said registration methodologies. In the example, information such as the keyword selected, the dimensional data of marked vector shape co-ordinates and other such information is saved to the data structure 22 with a unique mark identification code corresponding to the uniquely identified alphanumeric element number in the data structure 22. In this light, the image could have multiple uniquely identified marks per uniquely identified image saved in the data structure 22 corresponding to the number of said website users who activate the advertising module 20 and mark the image.

In the example, a second said user has also marked the image as highlighted in FIG. 7. The second user has marked a differently sized marked vector shape 300 for the same uniquely identified image element. When this second user attempts to start entering their keyword data in the ‘Keyword Annotation Data box’ 220 for the relevantly positioned vector shape co-ordinate, the advertising module 20 associates a second uniquely marked alphanumeric identification code to the current marked vector shape 300 and sends the co-ordinate and positioning data of this secondly marked vector shape to the data structure 22 in order to determine whether there is overlap and intersection between this second marked vector 300 shape and that of the first uniquely saved marked vector shape 280 in the data structure 22. If the method 24 determines that overlap exists, which in this non-limiting example it does, then as highlighted in FIG. 6 and FIG. 7, the advertising module 20 would present the first uniquely marked keyword in the data structure 22 to this second user. It is noted that if no vector shape overlap existed, then the advertising module 20 would recognise that no previous data has been saved in the data structure 22 and no previous data would appear.

While this process is being undertaken in the data structure 22, the second user has entered the keyword ‘Gucci Handbag’ and a number of results have been retrieved from the search algorithm from internal and external data sources as highlighted above. This second user has then been presented with differing data to that of the first user because of the slightly broader encompassing keyword and the second user is able to re-enter numerous search keywords in order to retrieve data in the search data list which is the correctly identified object in the image. However, in this case, the advertising module 20 has determined that said overlap exists in this second unique identified marked vector shape and dynamically returns the first users response to the Keyword Annotation Data Box 220 under the ‘Others Selected’ section, such that the second user is now presented with the first users. In the example, the second user then determines that this is the correct product and is also provided with a media preview 290 of this product.

The advertising module 20 then saves this selected keyword from the second user along with other information, such as the dimensional data of marked vector shape co-ordinates, element URL, internet protocol address (IP Address) to the data structure 22 with a unique mark identification code corresponding to the uniquely identified alphanumeric element number in the data structure 22. It is envisaged that this second user is registered with the system and therefore the advertising module 20 recognises that now two uniquely marked shape vector entries exist in the data structure 22 relevant to the uniquely identified image element which both have selected the same keyword. It is envisaged, that since the first user was not registered with the system, the internal ranking of the second user was sufficient—on the basis that this second user had previously identified other objects within other elements on other websites or in applications which have integrated the system code—and therefore the uniquely marked object has been confirmed within the image.

It is envisaged that the advertising module 20 would now recognise that a the co-ordinates of the object have been identified within a uniquely marked element on the Disney.com webpage and the advertising module 20 would then utilize the keyword product and/or advertising search algorithm to determine the most relevant highest based commission pricing the for the keyword. It is envisaged that this advertising search algorithm would attempt to find the most relevant product, advertiser and/or advertising list relevant to the confirmed keyword highlighted by the method above. It is envisaged that this process would create a list of quantifiable products, advertisers and/or advertising which are similar to the highlighted keyword in the data structure 22 which would then be retrievable by the binary system code for the purposes of redisplay over the advertising module 20 generated mid-point and or relevant point as determined by the advertising module 20 from the two aforementioned uniquely marked vector shapes co-ordinates within the uniquely identified webpage image element.

In an example, a product has been recognised as the top result by the advertising search algorithm from the Amazon.com data source which is accessible from the advertising search algorithm since both internal and external data sources can be accessed by the advertising search algorithm in the data structure 22.

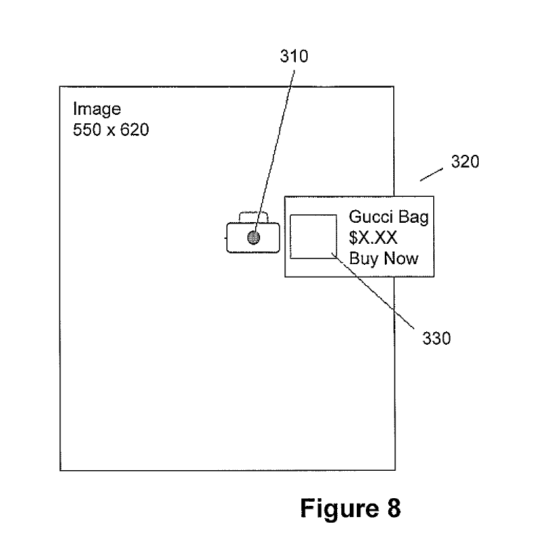

As seen in FIG. 8, the product is then redisplayed over the calculated marked vector shape area termed Marker Shape 310 with a unique system identification code for the purposes of tracking sales, commission and other tracking data for of income generation once any other user, visitor or member on the Disney.com website renders the webpage and uses an input device to activate the system binary code to display the identified object 330 in a relevant Advertising Display Box 320.

It is envisaged that the advertising display box 320 could render any advertising information which is returned from the advertising search algorithm relevant to the keyword identified by the user. In an example the advertising search algorithm has determined that Amazon.com has the highest commission paying result for Disney.com website users, visitors or members who subsequently activate the binary system code and view the information contained within the advertising display box 320. As described, visual media 330 (e.g. a picture) of the relevant product identified by the advertising search algorithm is retrieved and displayed in addition to, but in no way limiting, text, pricing information and a unique link which includes a tracking code for the purposes of commission sales leading from the sale of this product.

While in this non-limiting example, a product has been identified as the highest paying commission service by the advertising search algorithm, in other examples a text-advertisement or video advertisement or audio advertisement or any other type of advertising medium could be redisplayed and tracked by the advertising module 20 in order to determine income relevant to the uniquely marked element. That is, the advertising module 20 determines income relevant to the uniquely marked vector shape 310 and the confirmed user who specified and was deemed to have either firstly marked the object in the element or who was deemed to have confirmed the object in the element relevant to the data structure 22. It is envisaged that once a product has been confirmed relevant to the element and the positioning overlap of the marked vector shapes and a Marked Shape 310 has appeared then that future vector shape marks in that area may be ignored. It is further envisaged that any number of Marker Shapes can appear and display relevant advertising information relevant to the number of confirmed objects in the respective element or restriction per the customisation options of the website publisher.

It is envisaged that the method 24 would repeat itself any number of times on any number of elements recognised on a webpage relevant to the customisation restrictions of the publisher.

It is also envisaged that the method 24 would be able to involve any number of elements and any type of media such as, but not limited to, video, audio and other webpage or application elements, such that the shape vectorisation process could identify and allow a user to mark vector shapes within frames of a video or an audio file. In applying the concepts listed above, it is also possible that any type of media file could be utilised in order to allow user identification of object data within said media files. Furthermore, it is envisaged that the method 24 would be able to integrate its own advertising system which would rely on internal data as part of the search advertising algorithm and charge advertisers respectively according to, but in no way limited, the number of clicks or impressions or purchases or any other manner of advertising tracking. It is envisaged that each individual alphanumeric marked vector shape relevant to each individual alphanumeric marked element in the data structure 22 would be able to track the specific advertising confirmed for the purposes of matching income earned through the display of said advertising to that of the registered user, who relevantly is associated in the data structure 22 as having identified or confirmed the relevant keyword. In this regard, it is envisaged that the method 24 could be used distribute income to website publishers or application owners who have integrated the code and those users who individually marked vector shapes and provide keyword data. It is also possible that keyword searching could be extending to full text and natural language searching to increase the degree of relevancy of the object identification process.

It is further envisaged that the method 24 could be used could be incorporated into application interfaces such as gaming and 3D environments such that users within video games or 3D virtual worlds could identify particular objects and/or elements for targeting in order to display relevant product identification information and provide users with said income whether real or virtual income relevant to their game play when said objects are confirmed and displayed relevant information from the search advertising algorithm. In this regard, it is possible that the method 24 could be used could be extended to recognise the dimensions of the in game elements such that users, visitors or members of such applications can surround objects with vector markers inside the gaming environment in order to mark said content appropriately. This is additionally true for mobile platform technologies where it is possible for users to mark objects within applications of such platforms and identify them for the purposes of describing said elements and displaying information appropriately which, in a preferable embodiment, the user would then be paid for each time subsequent users of the application click on or touch or select or activate such marked and matched objects.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art in any country.

1. A method of advertising for objects displayed on a webpage of a website hosted by a web server accessible over a network, the method comprising:
electronically associating one or more objects displayed in an element on the webpage with respective keywords identifying the one or more objects;
retrieving advertising data for the one or more objects based on the respective keywords from at least one data store in data communication with the web server; and
outputting the advertising data with the one or more objects for display with the element on the webpage.

2. A method as claimed in claim 1, further comprising generating data corresponding to a user demarcation of the one or more objects displayed in the element.

3. A method as claimed in claim 2, further comprising generating further data corresponding to a subsequent user demarcation of the one or more objects displayed in the element.

4. A method as claimed in claim 3, further comprising comparing said data and said further data, and confirming position of the one or more objects displayed in the element if said data corresponds substantially to said further data.

5. A method as claimed in claim 4, further comprising storing said data in association with the advertising data for the one or more objects in the at least one data store.

6. A method as claimed in claim 1, further comprising receiving the respective keywords identifying the one or more objects from users accessing the webpage over the network.

7. A method as claimed in claim 6, further comprising generating keywords for selection by the users to further identify the one or more objects upon receipt of the respective keywords.

8. A system for advertising for objects, the system comprising:
a web server accessible over a network for outputting a webpage of a website hosted by the web server; and
an advertising module arranged to:
receive keywords identifying one or more objects displayed in an element on the webpage;
associate the one or more objects with the respective keywords;
retrieve advertising data for the one or more objects based on the respective keywords from at least one data store in data communication with the web server; and
output the advertising data with the one or more objects for display with the element on the webpage.

9. A system as claimed in claim 8, wherein the advertising module is further arranged to generate data corresponding to a user demarcation of the one or more objects displayed in the element.

10. A system as claimed in claim 9, wherein the advertising module is further arranged to generate further data corresponding to a subsequent user demarcation of the one or more objects displayed in the element.

11. A system as claimed in claim 10, wherein the advertising module is further arranged to compare said data and said further data, and confirm position of the one or more objects displayed in the element if said data corresponds substantially to said further data.

12. (canceled)

13. (canceled)

14. A system as claimed in claim 13, wherein the advertising module is further arranged to output the advertising data for the one or more objects for display with the element on the webpage to further users.

15. A system as claimed in claim 14, wherein the advertising module is further arranged to output the advertising data in response to a cursor position of the further users indicating the one or more objects displayed on the webpage.

16. (canceled)

17. (canceled)

18. (canceled)

19. A system as claimed in claim 8, wherein the advertising module is further arranged to receive the respective keywords identifying the one or more objects from users accessing the webpage over the network.

20. A system as claimed in claim 19, wherein the advertising module is further arranged to generate keywords for selection by the users to further identify the one or more objects upon receipt of the respective keywords.

21. A system as claimed in claim 8, wherein the advertising module is further arranged to designate elements on the webpage in which keywords identifying one or more objects displayed in those elements can be received.

22. (canceled)

23. A system as claimed in claim 8, wherein the advertising module is further arranged to generate a demarcation of the one or more objects displayed in the element for user confirmation.

24. A system as claimed in claim 23, wherein the advertising module is further arranged to generate the demarcation in response to a user cursor position indicating the one or more objects displayed on the webpage.

25. A system as claimed in claim 8, wherein the element comprises an image.

26. A tangible computer readable medium comprising computer program code which when executed implements the method of claim 1.

27. (canceled)

28. (canceled)
